(19) United States
(12) Patent Application Publication
(10) Pub. No.: US 2025/0014395 A1
(43) Pub. Date: Jan. 9, 2025

(54) Onboard Voice-Activated Vehicle Diagnostic Systems and Methods

(71) Applicant: Karma Automotive LLC, Irvine, CA (US)

(72) Inventors: Krishna Vanga, Irvine, CA (US); Sina Hamzehlouia, Irvine, CA (US)

(73) Assignee: Karma Automotive LLC, Irvine, CA (US)

(21) Appl. No.: 18/752,448

(22) Filed: Jun. 24, 2024

Related U.S. Application Data
(60) Provisional application No. 63/512,163, filed on Jul. 6, 2023.

(51) Int. Cl. G07C 5/00; G06F 3/16; G06F 40/40; G07C 5/08

(52) U.S. Cl. CPC G07C 5/008; G06F 3/167; G06F 40/40; G07C 5/0808; G07C 5/0825; G07C 5/085

(57) ABSTRACT

An onboard voice-activated vehicle diagnostic system for a vehicle includes an event data buffer, and an event data recorder configured to, while the vehicle is operating, record, in the event data buffer, event data received from one or more components of the vehicle. The system also includes an input interface configured to capture audio data representing an utterance spoken by an operator of the vehicle while operating the vehicle, and a network transceiver configured to communicate via a network. The system further includes a vehicle electronic control unit configured to determine, based on the audio data, that the operator triggered a diagnostic mode session and, in response to determining that the operator triggered the diagnostic mode session, communicate diagnostic data to a remote service center server via the network transceiver and the network, the diagnostic data including a pertinent portion of the event data and information representing the utterance.

### CROSS-REFERENCE TO RELATED APPLICATIONS

This U.S. patent application claims priority under 35 U.S.C. § 119(e) to U.S. Provisional Application 63/512,163, filed on Jul. 6, 2023. The disclosure of this prior application is considered part of the disclosure of this application and is hereby incorporated by reference in its entirety.

### TECHNICAL FIELD

This disclosure relates to on-board voice-activated vehicle diagnostics systems and methods.

### BACKGROUND

Event data recording systems are a common component of modern vehicles.

### SUMMARY

One aspect of the disclosure provides an onboard voice-activated vehicle diagnostic system for a vehicle. The system includes an event data buffer, an event data recorder, an input interface, a network transceiver, and a vehicle electronic control unit. The event data recorder configured to, while the vehicle is operating, record, in the event data buffer, event data received from one or more components of the vehicle. The input interface configured to capture audio data representing an utterance spoken by an operator of the vehicle while operating the vehicle. The network transceiver configured to communicate via a network. The vehicle electronic control unit configured to determine, based on the audio data, that the operator triggered a diagnostic mode session and, in response to determining that the operator triggered the diagnostic mode session, communicate diagnostic data to a remote service center server via the network transceiver and the network, the diagnostic data includes a pertinent portion of the event data and information representing the utterance.

Implementations of the disclosure may include one or more of the following optional features. In some implementations, the pertinent portion of the event data includes event data recorded prior to and after the diagnostic mode session is triggered. In some examples, the information representing the utterance includes a transcription of the utterance and/or the audio data. In some examples, determining, based on the audio data, that the operator triggered the diagnostic mode session includes determining that the audio data includes a hotword. In these examples, after determining that the audio data includes the hotword, the vehicle electronic control unit may be configured to determine, by processing the audio data with an automatic speech recognition system, the transcription of the utterance. In some examples, the vehicle electronic control unit is configured to process, using a natural language processing unit, the transcription of the utterance to determine a priority of the diagnostic mode session, and determine, based on the priority of the diagnostic mode session, when to communicate the diagnostic data to the remote service center server. Here, the priority of the diagnostic mode session may be a first priority associated with immediately communicating, while the vehicle is operating, the diagnostic data to the remote service center server, or a second priority associated with communicating, when the operator is no longer operating the vehicle, the diagnostic data to the remote service center server.

In some examples, the input interface is configured to capture the audio data responsive to the operator speaking a hotword. In other examples, the input interface is configured to capture the audio data when the operator activates a user interface element of an infotainment system or a button of the vehicle. In some implementations, the event data buffer includes a circular storage buffer, and the vehicle electronic control unit is configured to, in response to determining that the operator triggered the diagnostic mode session, trigger the event data recorder to store the pertinent portion of the event data in a non-volatile datastore.

In some implementations, the event data includes at least one of communication data associated with one or more communication systems of the vehicle, memory data associated with one or more electronic control units of the vehicle, or one or more diagnostic trouble codes. In some examples, communicating, via the network transceiver and the network, the diagnostic data to the remote service center server includes communicating the diagnostic data to a cloud-based data storage server accessible by the remote service center server. In some implementations, the vehicle electronic control unit is configured to receive, via the network transceiver and the network, diagnostic result information from the remote service center server, and display, on a display of the vehicle, the diagnostic result information.

Another aspect of the disclosure provides a computer-implemented method for performing an onboard voice-activated vehicle diagnostic for a vehicle. The computer-implemented method when executed on data processing hardware causes the data processing hardware to perform operations including recording event data received from one or more components of the vehicle in an event data buffer of the vehicle, and capturing audio data representing an utterance spoken by an operator of the vehicle while operating the vehicle. The operations also include determining, based on the audio data, that the operator triggered a diagnostic mode session while operating the vehicle and, in response to determining that the operator triggered the diagnostic mode session, communicating diagnostic data to a remote service center server via a network transceiver of the vehicle and a network, the diagnostic data includes a pertinent portion of the event data and information representing the utterance.

Implementations of the disclosure may include one or more of the following optional features. In some implementations, the pertinent portion of the event data includes event data recorded prior to and after the diagnostic mode session is triggered. In some examples, the information representing the utterance includes a transcription of the utterance and/or the audio data. In some implementations, determining, based on the audio data, that the operator triggered the diagnostic mode session includes determining that the audio data includes a hotword. In these implementations, after determining that the audio data includes the hotword, the operations also include determining, by processing the audio data with an automatic speech recognition system, the transcription of the utterance. In some implementations, the operations further include processing, using a natural language processing unit, the transcription of the utterance to determine a priority of the diagnostic mode session, and determining, based on the priority of the diagnostic mode session, when to communicate the diagnostic data to the remote service center server. Here, the priority of the diagnostic mode session may include a first priority associated with immediately communicating, while the vehicle is operating, the diagnostic data to the remote service center server, or a second priority associated with communicating, when the operator is no longer operating the vehicle, the diagnostic data to the remote service center server.

In some examples, the operations further include capturing the audio data responsive to the operator speaking a hotword. In some implementations, the operations further include capturing the audio data when the operator activates a user interface element of an infotainment system or a button of the vehicle. In some examples, the event data buffer includes a circular storage buffer, and the operations further include, in response to determining that the operator triggered the diagnostic mode session, storing the pertinent portion of the event data in a non-volatile datastore. In some implementations, the event data includes at least one of communication data associated with one or more communication systems of the vehicle, memory data associated with one or more electronic control units of the vehicle, or one or more diagnostic trouble codes. In some examples, communicating, via the network transceiver and the network, the diagnostic data to the remote service center server includes communicating the diagnostic data to a cloud-based data storage server accessible by the remote service center server. In some implementations, the operations further include receiving, via the network transceiver and the network, diagnostic result information from the remote service center server, and displaying, on a display of the vehicle, the diagnostic result information.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example onboard voice-activated vehicle diagnostic system.

FIG. 2 is a flowchart of an example arrangement of operations for a computer-implemented method for performing onboard voice-activated vehicle diagnostics.

FIG. 3 is a schematic view of an example computing device that may be used to implement the systems and methods described herein.

Like reference symbols in the various drawings indicate like elements.

### DETAILED DESCRIPTION

Modern vehicles may include tens or hundreds of electronic control units (ECUs), each of which is responsible for controlling a particular function or functions of a vehicle, including crucial and/or safety critical functions. Performing diagnostics for these ECUs requires receiving and storing event data, such as their inputs, outputs, state information and memory data, communication bus data, and diagnostic trouble codes (DTCs). Accordingly, event data recording systems are a common and increasingly essential component of modern vehicles. Event data recording systems continuously log specific event data for the various different vehicle components. In some examples, event data recorders log event data on an ongoing or regular basis. Additionally or alternatively, event data recorders log event data for a specified period prior to and following a trigger when and/or as triggered by pre-configured events and/or conditions. When a vehicle is taken to a service center, a service technician may review the logged event data for diagnosing vehicle malfunctions. For vehicles with connectivity systems, the vehicle may transfer event data to the cloud and/or remotely share the event data with a manufacturer and/or vehicle service center.

From a vehicle operator standpoint, this means that every time the operator (who may also be an owner) of a vehicle interprets or perceives a vehicle's behavior as a malfunction (whether it be from an actual or a perceived malfunction), they need to make an appointment at a vehicle service center and drop off the vehicle for hours or maybe days for diagnostics. In some cases, it is incredibly difficult to understand a reported malfunction without specific vehicle data corresponding to the reported malfunction. Moreover, an average operator may have limited understanding of how complex vehicle systems work, and a broad description by a vehicle operator regarding a reported malfunction might not be sufficient for supporting vehicle malfunction diagnostics by a service technician. Furthermore, when a reported malfunctions occurs during driving operations, especially during cornering or at highway speed driving, an operator may be unable to safely monitor and extract even very basic data from the vehicle, including the vehicle speed and steering angle, which may be critical to a service technician diagnosing the reported malfunction.

Additionally, while event data recorders typically have predefined event triggers that are designed to capture a broad range of potential scenarios, the predefined event triggers may not encompass every possible malfunction or issue that could occur with a vehicle. As a result, there may be situations where an operator of a vehicle reports a malfunction of their vehicle, but no corresponding event data is available to help diagnose the issue. This can lead to challenges for service technicians who are tasked with diagnosing and repairing reported malfunctions. Without the benefit of event data, a service technician may be forced to rely on more traditional or manual diagnostic techniques, which can be time-consuming and costly. In some cases, a service technician may not be able to identify the root cause of a reported malfunction, or rule out a reported malfunction as normal operation, which may result in a frustrating or unsuccessful experience for both the technician and the owner and/or operator.

Implementations disclosed herein are directed toward onboard voice-activated vehicle diagnostic systems and methods that enable an operator of a vehicle to, while operating (e.g., driving) the vehicle, safely, effectively, and verbally trigger a diagnostic mode session and report a vehicle malfunction. When a diagnostic mode session is verbally triggered, the onboard voice-activated vehicle diagnostic system initiates an audio recording session to record a spoken utterance of the operator describing (optionally in detail) a reported malfunction (e.g., “the motor did not respond as I attempted a hard acceleration”) to enable the operator to safely and effectively report the malfunction while operating the vehicle (e.g., driving). The onboard voice-activated vehicle diagnostic system also triggers an event data recording session to save past, current, and/or future potentially-relevant event data. The onboard voice-activated vehicle diagnostic system may then automatically communicate diagnostic data to a remote service center. The diagnostic data may include information related to the spoken utterance (e.g., captured audio data for, or a transcription of, the utterance spoken during the audio recording session) and logged event data of the event data recording session to a remote service center. In some implementations, the onboard voice-activated vehicle diagnostic system communicates the diagnostic data to the remote service center via cloud-based data storage sever that is accessible to the remote service center. The onboard voice-activated vehicle diagnostic system enables remote, time efficient, and cost-effective means for diagnosing reported vehicle malfunctions. The onboard voice-activated vehicle diagnostic system may also be used by a vehicle manufacturer during vehicle development for safely and effectively reporting vehicle issues identified by the test engineers and/or test drivers.

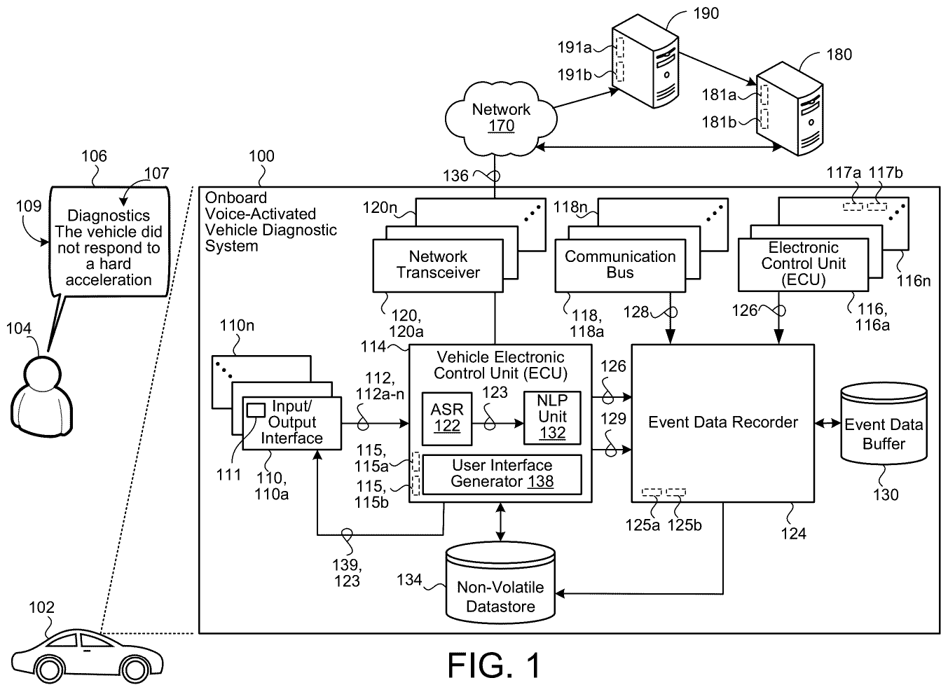

FIG. 1 is a schematic view of an example of an onboard voice-activated vehicle diagnostic system 100 for a vehicle 102. While FIG. 1 depicts the vehicle 102 as a car, the vehicle 102 may be any type of vehicle including, but not limited to, a car, a van, a sport utility vehicle, a delivery vehicle, a truck, a motorcycle, a piece of construction equipment, a train, an airplane, and a spacecraft. An operator 104 of the vehicle 102 (who may also be an owner of the vehicle 102) may interact with the onboard voice-activated vehicle diagnostic system 100 through voice input, among possibly other types of user input. The onboard voice-activated vehicle diagnostic system 100 is configured to capture sounds from the operator 104 as streaming audio data. Here, the streaming audio data may refer to an utterance 106 spoken by the operator 104 that functions as an audible command to trigger a diagnostic mode session of the onboard voice-activated vehicle diagnostic system 100 and to report a vehicle malfunction. In one example, the operator 104 may speak a hotword as an invocation phrase of a single term (e.g., “diagnostics”) or multiple terms (e.g., “start diagnostics” or “hey car start diagnostics”) to trigger the diagnostic mode session. Alternatively, the operator 104 may activate the diagnostic mode session by, for example, pressing a button on a steering wheel or dashboard, or activating a user interface element of an infotainment screen.

The onboard voice-activated vehicle diagnostic system 100 includes, or is communicatively coupled to, one or more input/output interfaces 110, 110a-n of the vehicle 102 for capturing and converting user inputs (e.g., spoken utterances, button presses, infotainment system activations, etc.) into electrical signals or data 112, 112a-n, and converting electrical signals or data 112 into outputs for the operator 104 (e.g., displaying information on a dashboard of the vehicle 102). Example input/output interfaces 110 include, without limit, one or more audio capture devices (e.g., microphones) for capturing and converting a spoken utterance 106 into digital audio data 112 associated with input acoustic frames capable of being input to and processed by an ASR system 122 to generate/predict, as output, a corresponding transcription 123 for the spoken utterance 106; one or more audio output device (e.g., a speaker) for communicating audible audio signals (e.g., output audio data from the onboard voice-activated vehicle diagnostic system 100); a button of a steering wheel or dashboard of the vehicle 102; an infotainment system of the vehicle 102; a dashboard of the vehicle 102, and a user device (e.g., a mobile phone) communicatively coupled to the vehicle 102. The input/output interface 110 may also include a hotword detector 111 that is configured to detect the presence of a predefined hotword 106 in an utterance 106 spoken by the operator 104 in streaming audio data without performing speech recognition processing on the audio data. When the hotword detector 111 detects the presence of the hotword in the streaming audio data, the input/output interface 110 may invoke the ASR system 122 to process the audio data to generate the transcription 123 for the utterance 106 which includes the hotword 107 followed by a diagnostic report (e.g., “The vehicle did not respond to a hard acceleration”) 109. In some scenarios, the ASR system 122 may only process audio data subsequent to a portion of the audio data that includes the hotword 107 so that only a transcription of the diagnostic report 109 is generated.

The onboard voice-activated vehicle diagnostic system 100 includes, or is communicatively coupled to, a vehicle electronic control unit (ECU) 114 of the vehicle 102. Notably, the hotword detector 111 may also execute on the ECU 114. The vehicle ECU 114 may be a main, primary, or central ECU of the vehicle 102. The vehicle ECU 114 includes respective data processing hardware 115a, and memory hardware 115b in communication with the data processing hardware 115a. The memory hardware 115b stores instructions that, when executed by the data processing hardware 115a cause the data processing hardware 115a to perform one or more operations, such as those disclosed herein.

In the example shown, the vehicle ECU 114 is in communication with one or more components of the vehicle 102. For example, the vehicle ECU 114 may be in communication with one or more other ECUs 116, 116a-n of the vehicle 102 via one or more communication buses 118, 118a-n (e.g., a controller area network (CAN) bus, a local interconnect network (LIN) bus, a FlexRay bus, or an Ethernet network) of the vehicle 102. The ECUs 116 are each responsible for controlling a particular function or functions (e.g., engine, braking, climate, security, communication, infotainment, etc.) of the vehicle 102, possibly including crucial and/or safety critical functions. Each of the ECUs 116 includes respective data processing hardware 117a, and respective memory hardware 117b in communication with the data processing hardware 117a. The memory hardware 117b stores instructions that, when executed by the data processing hardware 117a cause the data processing hardware 117a to perform one or more operations, such as those disclosed herein.

The vehicle ECU 114 is also in communication with one or more network transceivers 120, 120a-n that enable the vehicle ECU 114 to communicate with other devices and/or systems. Example network transceivers 120 include, but are not limited to, a cellular network transceiver, a WiFi network transceiver, and a Bluetooth network transceiver.

The onboard voice-activated vehicle diagnostic system 100 includes an automatic speech recognition (ASR) system 122 for processing captured audio data 112 representing a spoken utterance 106 to determine a transcription 123 of the spoken utterance 106. In the example shown, the ASR system 122 is implemented on the vehicle 102 by the vehicle ECU 114. However, the ASR system 122 may be implemented by one of the other ECUs 116. Moreover, the ASR system 122 may be implemented by a remote computing device (e.g., one or more remote servers of a distributed system executing in a cloud-computing environment) in communication with the vehicle 102 via a network 170. For example, the vehicle ECU 114 may communicate captured audio data 112 to the remote computing device via the network 170 and receive, in return, transcriptions 123 of the captured audio data 112 from the remote computing device via the network 170. The ASR system 122 may implement any number and/or type(s) of past, current or future speech recognition models and/or methods including, but not limited to, a recurrent neural network-transducer (RNN-T) model, an end-to-end speech recognition model, a hidden Markov model, a set of acoustic, language and pronunciation models, and a naïve Bayes classifier.

The onboard voice-activated vehicle diagnostic system 100 includes an event data recorder 124 for recording or logging event data 126, 128 received from one or more components of the vehicle 102 (e.g., from the ECUs 114, 116 and/or the communication buses 118) in an event data buffer 130. Event data 126, 128 includes, but is not limited to, inputs, outputs, state information, and memory data of the ECUs 114, 116, communication data of the communication buses 118, and diagnostic trouble codes (DTCs). In some examples, the event data recorder 125 logs event data 126, 128 on an ongoing or regular basis. Additionally or alternatively, the event data recorder 124 logs event data 126, 128 for a specified or predetermined period of time prior to, during and following a trigger 129 when and/or as triggered by a pre-configured event and/or condition. In some examples, the predetermined period of time is pre-defined by the manufacturer of the vehicle 102 and can be calibrated by the manufacturer as needed. Here, a trigger includes the verbal triggering of a diagnostic mode session by the operator 104, while operating the vehicle 102, to report a vehicle malfunction. In some examples, the event data buffer 130 includes a circular storage buffer implemented using a singly-linked list of a set buffer size. In such examples, the event data recorder 124 overwrites the oldest event data 126, 128 in the event data buffer 130 when storing new event data 126, 128 in the event data buffer 130. The event data recorder 124 includes data processing hardware 125a, and memory hardware 125b in communication with the data processing hardware 125a. The memory hardware 125b stores instructions that, when executed by the data processing hardware 125a cause the data processing hardware 125a to perform one or more operations, such as those disclosed herein.

Regardless of how a diagnostic mode session is activated (e.g., in response to a spoken hotword 107, a button press, or an infotainment interface activation), the onboard voice-activated vehicle diagnostic system 100 (e.g., the vehicle ECU 114) initiates an audio recording session to record a diagnostic report 109 spoken in the utterance 106 by the operator 104 that describes (optionally in detail) a reported malfunction (e.g., “the vehicle did not respond as I attempted a hard acceleration”) to enable the operator 104 to safely and effectively report the malfunction while operating (e.g., driving) the vehicle 102. The onboard voice-activated vehicle diagnostic system 100 (e.g., the vehicle ECU 114) also triggers or causes the event data recorder 125 to initiate an event data recording session for the diagnostic mode session. Then event data recorder 125 logs event data 126, 128 for the event data recording session in the event data buffer 130. In some examples, the event data recording session includes event data 126, 128 for a specified or predetermined period of time prior to, during, and following the triggering of the diagnostic mode session by the operator 104.

In some implementations, the vehicle ECU 114 includes a natural language processing (NLP) unit 132 for processing a transcription of the audio recording session to determine what type(s) of event data 126, 128 the event data recorder 124 is to log; from which ECUs 114, 116 and/or from which communication buses 118 the event data recorder 124 is to log event data 126, 128; and/or over what time period(s) the event data recorder 124 is to log event data 126, 128. After the event data recorder 124 completes the event data recording session, the event data recorder 124 stores the logged event data 126, 128 for the event data recording session (i.e., a pertinent portion of the event data 126, 128 stored in the event data buffer 130) in a non-volatile datastore 134 accessible to the vehicle ECU 114 (or another designated ECU identified and set up by the manufacturer of the vehicle 102). Notably, information related to the spoken utterance 106 of the diagnostic mode session (e.g., captured audio data for, or a transcription 123 of, the audio recording session) and the logged event data 126, 128 for the event data recording session are stored in the non-volatile datastore 134 to ensure they are not discarded or overwritten. Alternatively, the vehicle ECU 114 accesses the logged event data 126, 128 for the event data recording session from the event data buffer 130.

In the example shown, the vehicle ECU 114 communicates diagnostic data 136 for the diagnostic mode session to a remote service center server 180 via a network transceiver 120 and an associated network 170. The diagnostic data 136 may include information related to the spoken utterance describing the report malfunction (e.g., captured audio data for, or a transcription 123 of, the spoken utterance) and logged event data 126, 128 for the event data recording session to a remote service center server 180. In some implementations, the vehicle ECU 114 communicates the diagnostic data 136 to the remote service center server 180 via a cloud-based data storage server 190 that is accessible to the remote service center server 180. In some examples, the remote service center server 180 or the cloud-based data storage server 190 implements a remote computing device for processing audio data to determine a transcription for the audio data on behalf of the onboard voice-activated vehicle diagnostic system 100. The remote service center server 180 includes data processing hardware 181a, and memory hardware 181b in communication with the data processing hardware 181a. The memory hardware 181b stores instructions that, when executed by the data processing hardware 181a cause the data processing hardware 181a to perform one or more operations, such as those disclosed herein. The cloud-based data storage server 190 includes data processing hardware 191a, and memory hardware 191b in communication with the data processing hardware 191a. The memory hardware 191b stores instructions that, when executed by the data processing hardware 191a cause the data processing hardware 191a to perform one or more operations, such as those disclosed herein.

In some implementations, the NLP unit 132 processing the transcription 123 of the audio recording session of a diagnostic mode session to determine a priority of the diagnostic mode session, and the vehicle ECU 114 determines, based on the priority, when or how soon to communicate the diagnostic data 136 to the remote service center server 180. For example, for a first priority (e.g., a high priority malfunction associated with potential vehicle damage or a potential safety issue), the vehicle ECU 114 may communicate the diagnostic data 136 to the remote service center server 180 or the cloud-based data storage server 190 immediately, or as soon as network connection is available (including, but not limited to, a cellular or Wifi network), to the remote service center server 180. Otherwise, for a second priority (e.g., a lower priority malfunction associated with a sound system), the vehicle ECU 114 may communicate the diagnostic data 136 at a later time, such when the operator 104 is no longer operating the vehicle 102 (e.g., when the operator 104 turns off the vehicle 102). Different pre-defined hotwords may be spoken by the operator 106 to not only invoke the ASR 122, but may also indicate the priority of the diagnostic mode session. For instance, a first pre-defined hotword 107 such as “Red Alert” may indicate that the diagnostic data 136 aligned with the spoken diagnostic report 109 is associated with the first priority while a second pre-defined hotword 107 such as “Diagnostics” may indicate that the diagnostic data 136 aligned with the following spoken diagnostic report 109 is associated with the second priority. Notably, the NLP unit 132 may perform semantic analysis on the transcription 123 to determine the priority of the diagnostic data. The NLP unit 132 may additionally or alternatively perform sentiment analysis on the transcription 123 to determine the priority of the diagnostic data.

In some implementations, the onboard voice-activated vehicle diagnostic system 100 (e.g., the vehicle ECU 114) includes a user interface generator 138 configured to present diagnostic result information 139 for a diagnostic mode session provided by the remote service center server 180 in response to the diagnostic data 136. The result information (or simply ‘results’) 139 may be presented on an input/output interface 110 that includes a display screen of the vehicle 102 (e.g., on a dashboard or infotainment screen), may be audibly output by an input/output interface 110 of the vehicle 102, or may be presented via a user device communicatively coupled to the vehicle 102. Example results 139 include, but are not limited to an indication of a cause of reported malfunction, that the reported malfunction is a normal operation of the vehicle 102, that the reported malfunction can be remotely corrected pending operator/owner approval (e.g., via a software update), that the report malfunction has been remotely corrected (e.g., by adjusting a setting of the vehicle 102), that the vehicle 102 needs to be brought in for in-person service, and/or a priority for in-person service. The user interface generator 138 may also present the transcription 123 for output from the input/output interface. In some scenarios, the operator 102 may interact with a graphical user interface to edit a transcription 123 that was misrecognized by the ASR system 122 by manually selecting and typing misrecognized terms in the transcription 123 and/or repeating the utterance 106 of the reporting condition 109.

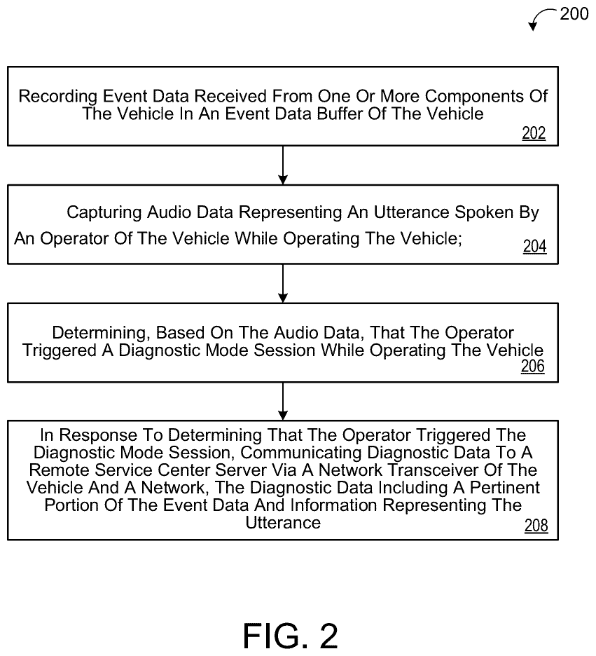

FIG. 2 is a flowchart of an exemplary arrangement of operations for a computer-implemented method 200 for performing onboard voice-activated vehicle diagnostics for a vehicle. At operation 202, the method 200 includes recording event data 126, 128 received from one or more components 114, 116, and 118 of the vehicle 102 in an event data buffer 130 of the vehicle 102. The method 200 includes, at operation 204, capturing audio data 112 representing an utterance 106 spoken by an operator 104 of the vehicle 102 while operating the vehicle 102.

At operation 206, the method 200 includes determining, based on the audio data 112, that the operator 104 triggered a diagnostic mode session while operating the vehicle 102. The method includes, at operation 208, in response to determining that the operator 104 triggered the diagnostic mode session, communicating diagnostic data 136 to a remote service center server 180 via a network transceiver 120 of the vehicle 102 and a network 170, the diagnostic data 136 including a pertinent portion of the event data 126, 128 and information representing the utterance 106.

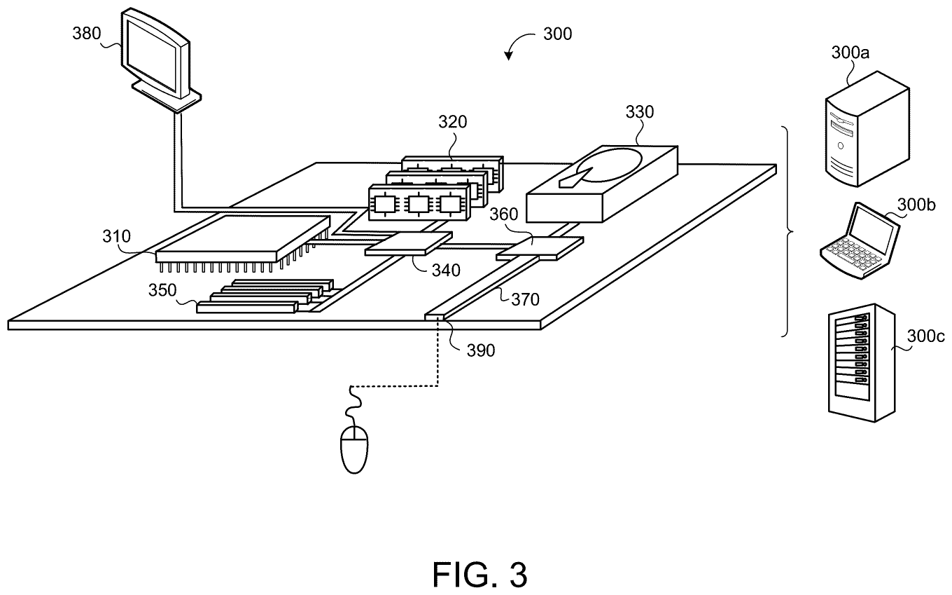

FIG. 3 is schematic view of an example computing device 300 that may be used to implement the systems and methods described in this document. The computing device 300 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 300 includes a processor 310 (i.e., data processing hardware) that can be used to implement the data processing hardware 115a, 117a, 125a, 181a and/or 191a, memory 320 (i.e., memory hardware) that can be used to implement the memory hardware 115b, 117b, 125b, 181b and/or 191b, a storage device 330 (i.e., memory hardware) that can be used to implement the memory hardware 115b, 117b, 125b, 181b and/or 191b, the event data buffer 130, and/or the non-volatile datastore 134, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 can process instructions for execution within the computing device 300, including instructions stored in the memory 320 or on the storage device 330 to display graphical information for a graphical user interface (GUI) on an external input/output device, such as display 380 coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 stores information non-transitorily within the computing device 300. The memory 320 may be a computer-readable medium, a volatile memory unit(s), or non-volatile memory unit(s). The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 300a or multiple times in a group of such servers 300a, as a laptop computer 300b, or as part of a rack server system 300c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. An onboard voice-activated vehicle diagnostic system for a vehicle, the system comprising:
an event data buffer;
an event data recorder configured to, while the vehicle is operating, record, in the event data buffer, event data received from one or more components of the vehicle;
an input interface configured to capture audio data representing an utterance spoken by an operator of the vehicle while operating the vehicle;
a network transceiver configured to communicate via a network; and
a vehicle electronic control unit configured to:
determine, based on the audio data, that the operator triggered a diagnostic mode session; and
based on determining that the operator triggered the diagnostic mode session, communicate diagnostic data to a remote service center server via the network transceiver and the network, the diagnostic data comprising a pertinent portion of the event data and information representing the utterance.

2. The system of claim 1, wherein the pertinent portion of the event data comprises event data recorded prior to and after the diagnostic mode session is triggered.

3. The system of claim 1, wherein the information representing the utterance comprises a transcription of the utterance and/or the audio data.

4. The system of claim 3, wherein determining, based on the audio data, that the operator triggered the diagnostic mode session comprises determining that the audio data comprises a hotword.

5. The system of claim 4, wherein, after determining that the audio data comprises the hotword, the vehicle electronic control unit is configured to determine, by processing the audio data with an automatic speech recognition system, the transcription of the utterance.

6. The system of claim 3, wherein the vehicle electronic control unit is configured to:
process, using a natural language processing unit, the transcription of the utterance to determine a priority of the diagnostic mode session; and
determine, based on the priority of the diagnostic mode session, when to communicate the diagnostic data to the remote service center server.

7. The system of claim 6, wherein the priority of the diagnostic mode session comprises:
a first priority associated with immediately communicating, while the vehicle is operating, the diagnostic data to the remote service center server, or
a second priority associated with communicating, when the operator is no longer operating the vehicle, the diagnostic data to the remote service center server.

8. The system of claim 1, wherein the input interface is configured to capture the audio data responsive to the operator speaking a hotword.

9. The system of claim 1, wherein the input interface is configured to capture the audio data when the operator activates a user interface element of an infotainment system or a button of the vehicle.

10. The system of claim 1, wherein:
the event data buffer comprises a circular storage buffer; and
the vehicle electronic control unit is configured to, in response to determining that the operator triggered the diagnostic mode session, trigger the event data recorder to store the pertinent portion of the event data in a non-volatile datastore.

11. The system of claim 1, wherein the event data comprises at least one of communication data associated with one or more communication systems of the vehicle, memory data associated with one or more electronic control units of the vehicle, or one or more diagnostic trouble codes.

12. The system of claim 1, wherein communicating, via the network transceiver and the network, the diagnostic data to the remote service center server comprises communicating the diagnostic data to a cloud-based data storage server accessible by the remote service center server.

13. The system of claim 1, wherein the vehicle electronic control unit is configured to:
receive, via the network transceiver and the network, diagnostic result information from the remote service center server; and
display, on a display of the vehicle, the diagnostic result information.

14. A computer-implemented onboard voice-activated vehicle diagnostic method for a vehicle, the method, when executed on data processing hardware, causes the data processing hardware to perform operations comprising:
recording event data received from one or more components of the vehicle in an event data buffer of the vehicle;
capturing audio data representing an utterance spoken by an operator of the vehicle while operating the vehicle;
determining, based on the audio data, that the operator triggered a diagnostic mode session while operating the vehicle; and
based on determining that the operator triggered the diagnostic mode session, communicating diagnostic data to a remote service center server via a network transceiver of the vehicle and a network, the diagnostic data comprising a pertinent portion of the event data and information representing the utterance.

15. The method of claim 14, wherein the pertinent portion of the event data comprises event data recorded prior to and after the diagnostic mode session is triggered.

16. The method of claim 14, wherein the information representing the utterance comprises a transcription of the utterance and/or the audio data.

17. The method of claim 16, wherein determining, based on the audio data, that the operator triggered the diagnostic mode session comprises determining that the audio data comprises a hotword.

18. The method of claim 17, wherein, after determining that the audio data comprises the hotword, determining, by processing the audio data with an automatic speech recognition system, the transcription of the utterance.

19. The method of claim 16, wherein the operations further comprise:
processing, using a natural language processing unit, the transcription of the utterance to determine a priority of the diagnostic mode session; and
determining, based on the priority of the diagnostic mode session, when to communicate the diagnostic data to the remote service center server.

20. The method of claim 19, wherein the priority of the diagnostic mode session comprises:
a first priority associated with immediately communicating, while the vehicle is operating, the diagnostic data to the remote service center server, or
a second priority associated with communicating, when the operator is no longer operating the vehicle, the diagnostic data to the remote service center server.

21. The method of claim 14, wherein the operations further comprise capturing the audio data in response to the operator speaking a hotword.

22. The method of claim 14, wherein the operations further comprise capturing the audio data when the operator activates a user interface element of an infotainment system or a button of the vehicle.

23. The method of claim 14, wherein:
the event data buffer comprises a circular storage buffer; and
the operations further comprise, in response to determining that the operator triggered the diagnostic mode session, storing the pertinent portion of the event data in a non-volatile datastore.

24. The method of claim 14, wherein the event data comprises at least one of communication data associated with one or more communication systems of the vehicle, memory data associated with one or more electronic control units of the vehicle, or one or more diagnostic trouble codes.

25. The method of claim 14, wherein communicating, via the network transceiver and the network, the diagnostic data to the remote service center server comprises communicating the diagnostic data to a cloud-based data storage server accessible by the remote service center server.

26. The method of claim 14, wherein the operations further comprise:
receiving, via the network transceiver and the network, diagnostic result information from the remote service center server; and
displaying, on a display of the vehicle, the diagnostic result information.
